(19) United States
(12) Patent Application Publication
(10) Pub. No.: US 2021/0132398 A1
(43) Pub. Date: May 6, 2021

(54) HEAD-MOUNTED DISPLAY

(71) Applicant: SEIKO EPSON CORPORATION, Tokyo (JP)

(72) Inventor: Takeshi FUJISHIRO, SHIOJIRI-SHI, NAGANO-KEN (JP)

(73) Assignee: SEIKO EPSON CORPORATION, Tokyo (JP)

(21) Appl. No.: 17/080,774

(22) Filed: Oct. 26, 2020

(30) Foreign Application Priority Data
Oct. 31, 2019 (JP) 2019-198379

(51) Int. Cl. G02B 27/01; G02C 3/00; G02C 5/12; G02C 5/20; G02C 5/22

(52) U.S. Cl. CPC G02B 27/0176; G02C 3/003; H04R 1/323; G02C 5/20; G02C 5/2209; G02C 5/12

(57) ABSTRACT

A head-mounted display includes an optical device that is an image light generating device that forms a virtual image, and a support device that includes a pair of temples and supports the image light generating device from above. The temple includes a contact unit coupled to a main body of the temple by a universal joint, and causes the contact unit to come into contact with a flat portion, for example.

The present application is based on, and claims priority from JP Application Serial Number 2019-198379, filed Oct. 31, 2019, the present disclosure of which is hereby incorporated by reference herein in its entirety.

### BACKGROUND

### 1. Technical Field

The present disclosure relates to a head-mounted display that presents a virtual image to an observer, and particularly to a head-mounted display mounted on the head of the observer.

### 2. Related Art

As a head-mounted display, an image output unit for a single eye, an acoustic output unit for both ears, and a support unit for detachably mounting these on the head of a user is known (JP-A-2004-233904). The head-mounted display (hereinafter, also referred to as “HMD”) is mounted so as to sandwich the head of the user, and the support unit includes a band extending along the back of the head and supports a pair of the acoustic output units that cover the ears at both ends of the band.

In the device disclosed in JP-A-2004-233904, in order to support the HMD on the head using only the acoustic output units including ear pads, the acoustic output unit is made larger so as to cover the entire ear, and a holding force with respect to the HMD is secured. Thus, for example, perception of necessary environmental sound is inhibited, and there is also an increase in limitations relating to an external appearance shape due to the large acoustic output unit that covers the entire ear.

### SUMMARY

A head-mounted display (HMD) according to an aspect of the present disclosure includes an image light generating device configured to form a virtual image, and a support device including a pair of temples and configured to support the image light generating device from above. The temple includes a contact unit coupled to a main body of the temple by a universal joint, and causes the contact unit to contact with pressure.

### BRIEF DESCRIPTION OF THE DRAWINGS

FIG. 1 is a perspective view illustrating an HMD according to an embodiment when in use.

FIG. 2 is a side view illustrating the HMD when in use.

FIG. 3 is a plan view and a front view illustrating a specific appearance of the HMD.

FIG. 4 is a bottom view, a rear view, and a left side view illustrating the specific appearance of the HMD.

FIG. 5 is a perspective view of the HMD as viewed from the front right upper side and a perspective view of the HMD as viewed from the rear left upper side.

FIG. 6 is a plan view illustrating a state in which no external force is applied to temples.

FIG. 7 is a front view and a perspective view illustrating a state in which a shade is mounted.

FIG. 8 is a plan view and a front view of the HMD.

FIG. 9 is a plan view and a right side view of the HMD.

FIG. 10 is a plan view, a side view, and a rear view illustrating an appearance of a contact unit and a periphery thereof.

FIG. 11 is a plan view, a side view, and a rear view illustrating a movable state of the contact unit.

FIG. 12 is a plan view illustrating a temple length adjustment structure.

FIG. 13 is a perspective view illustrating a base of a support device.

FIG. 14 is a conceptual partial side cross-sectional view illustrating a periphery of the base.

FIG. 15 is a diagram illustrating a modified example of a nose pad illustrated in FIG. 14.

FIG. 16 is a diagram illustrating another modified example of the nose pad illustrated in FIG. 14.

FIG. 17 is a conceptual side view illustrating a lifting up or rotational retraction of an optical device.

FIG. 18 is a plan view illustrating the optical device of the HMD.

FIG. 19 is a conceptual block diagram illustrating a circuit configuration of the HMD.

FIG. 20 is a plan view illustrating an optical structure of a first virtual image forming optical unit.

FIG. 21 is a side view illustrating a modified example of a method for fixing a camera.

### DESCRIPTION OF EXEMPLARY EMBODIMENTS

Below, a head-mounted display according to an embodiment of the present disclosure will be described with reference to the accompanying drawings.

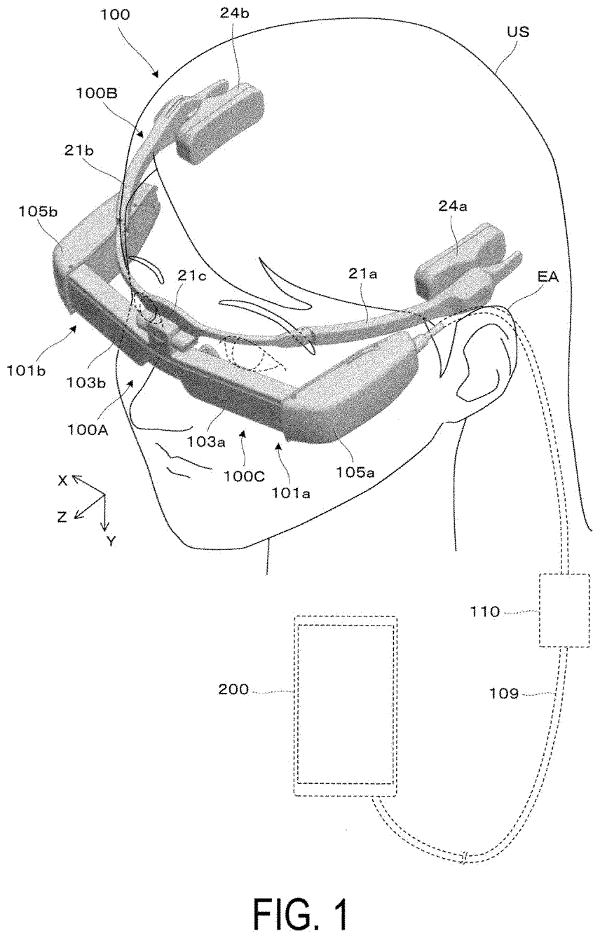

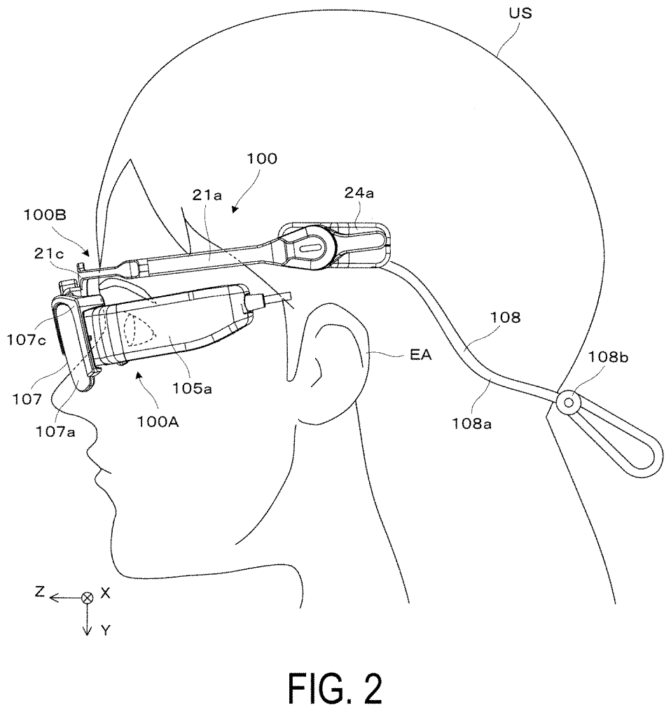

As illustrated in FIG. 1 and FIG. 2, a head-mounted display (HMD) 100 of the embodiment is a mounted display device having an appearance like glasses. In FIG. 1 and the like, X, Y, and Z are an orthogonal coordinate system, a positive X direction corresponds to a lateral direction in which both eyes of an observer or a wearer US wearing the HMD 100 are aligned, a positive Y direction corresponds to a downward direction orthogonal to the lateral direction in which both the eyes of the wearer US are aligned, a negative Y direction corresponds to an upward direction orthogonal to the lateral direction, and a positive Z direction corresponds to a forward direction or a front-facing direction of the wearer US.

The HMD 100 is a see-through type HMD, and not only can a virtual image be viewed by the observer or the wearer US wearing the HMD 100, but an external world image can also be viewed in a see-through manner. The HMD 100 can be communicatively coupled to an external device 200, such as a smartphone, via a cable 109, and can form the virtual image in response to a video signal input from the external device 200, for example. In an example illustrated, a relay 110 is incorporated that performs signal processing between the HMD 100 and the external device 200, but the relay 110 can be omitted, and the HMD 100 and the external device 200 can be directly coupled to each other.

The HMD 100 includes an optical device 100A, which is an image light generating device that forms the virtual image, and a support device 100B that supports the optical device 100A from above. In this case, the support device 100B is fixed in a stable state on the head of the wearer US as a mounting member, and the optical device 100A is supported by the support device 100B and is disposed in a desired posture in front of the eyes of the wearer US.

The optical device (image light generating device) 100A is provided with a first display device 101a and a second display device 101b. The first display device 101a and the second display device 101b are portions that respectively form a virtual image for the left eye and a virtual image for the right eye. The support device 100B is provided with a first temple 21a, a second temple 21b, and a base unit 21c. The first temple 21a and the second temple 21b are respectively supported on the left and right ends of the base unit 21c at a base side of each of the first temple 21a and the second temple 21b, and the base unit 21c is coupled to the optical device 100A at a lower center portion thereof.

The HMD 100 illustrated in FIG. 2 is in a state in which a shade 107 that limits transmitted light is attached to the front face side of the optical device 100A so as to cover the optical device 100A. In addition, an auxiliary member 108 that prevents falling is attached to the HMD 100 illustrated in FIG. 2, the auxiliary member 108 extending between the end of the first temple 21a and the end of the second temple 21b.

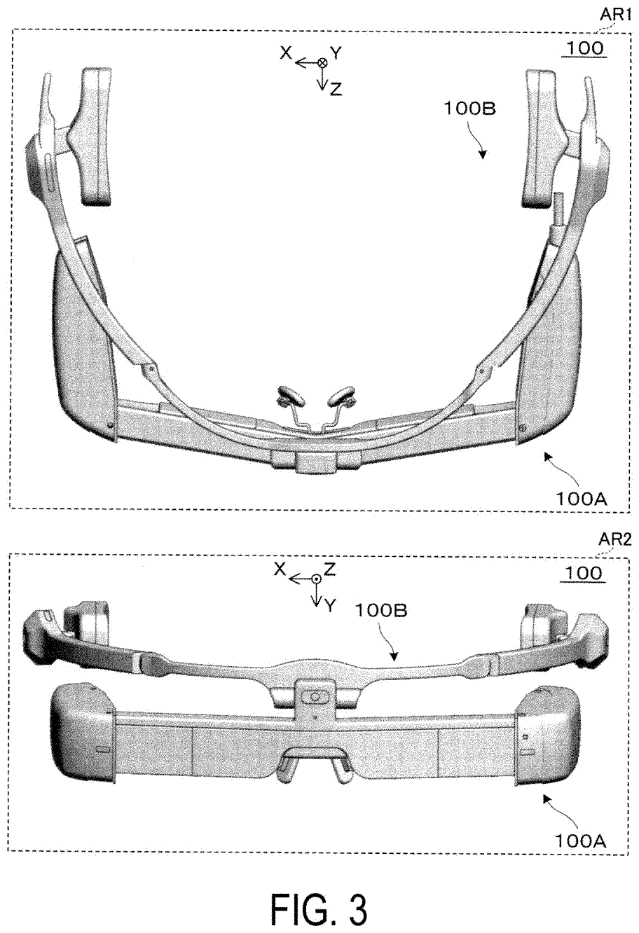

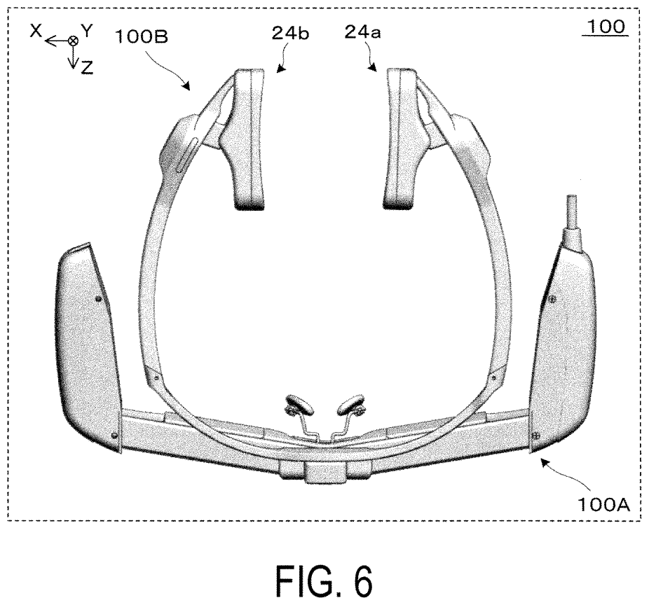

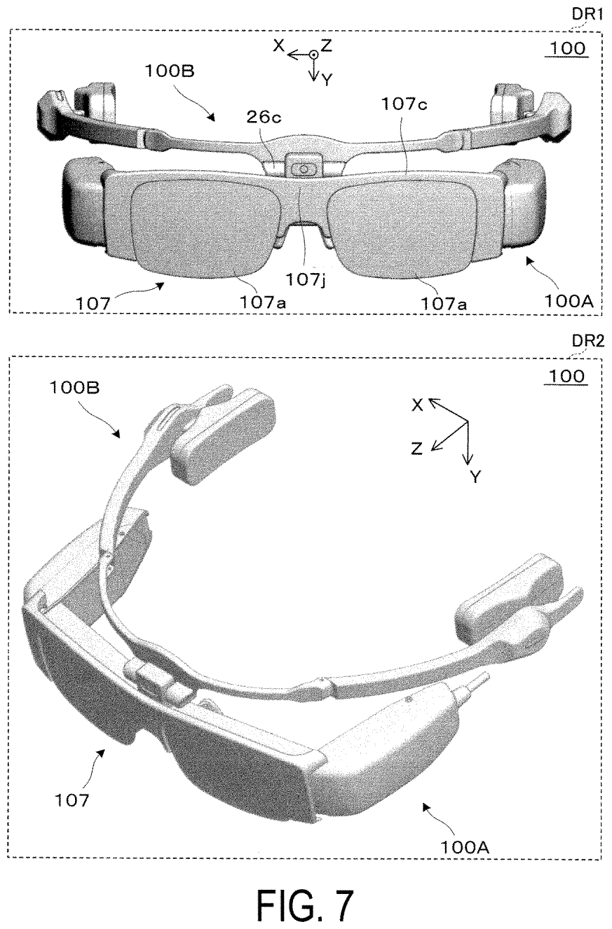

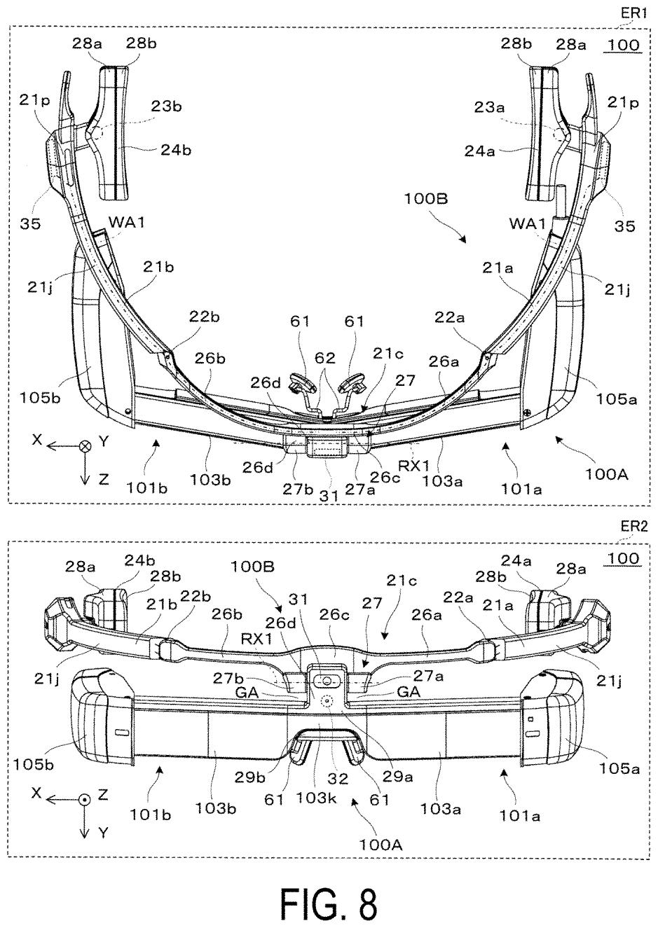

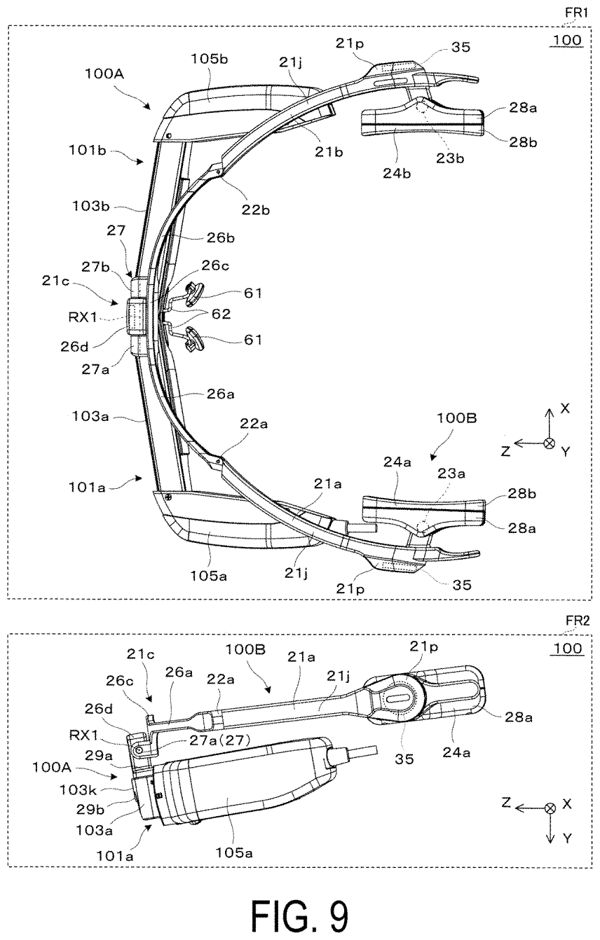

FIG. 3 to FIG. 5 are diagrams illustrating the appearance of the HMD 100 when in use, FIG. 6 is a diagram illustrating an appearance of the HMD 100 when not in use, and FIG. 7 is a diagram illustrating the appearance of the HMD 100 when in use, with the shade 107 attached. In FIG. 3 to FIG. 7, shade depicted over the entire surface of surface portions is in all cases used to specify a shape of a three-dimensional surface. FIG. 8 and FIG. 9 are line diagrams illustrating the appearance of the HMD 100 when in use.

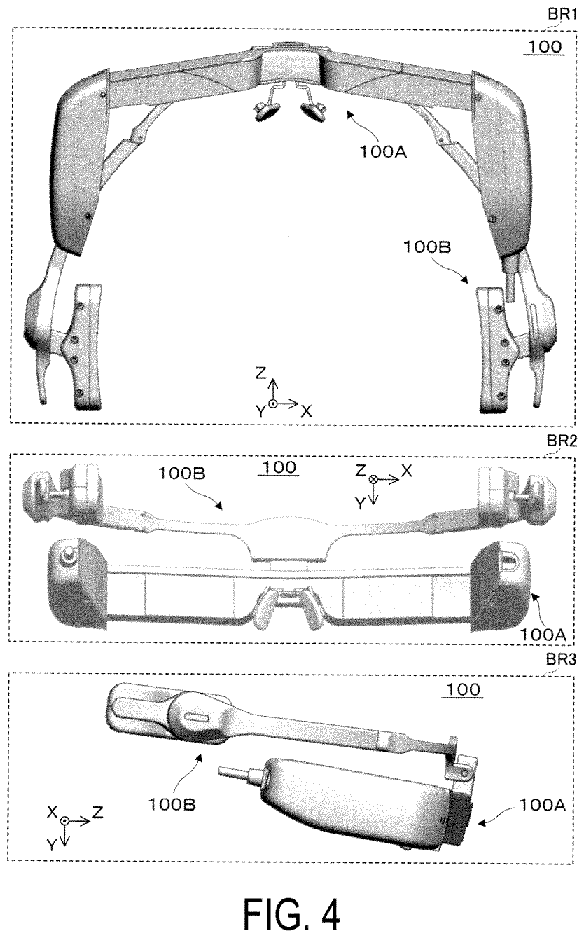

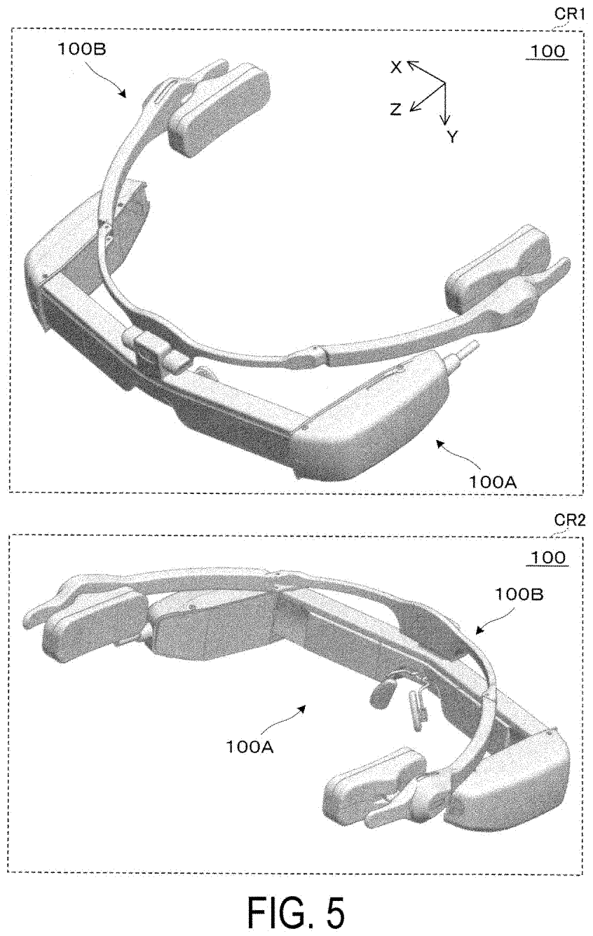

In FIG. 3, a first area AR1 is a plan view of the HMD 100 when in use and a second area AR2 is a front view of the HMD 100 when in use. In FIG. 4, a first area BR1 is a bottom view of the HMD 100 when in use, a second area BR2 is a back view of the HMD 100 when in use, and a third area BR3 is a left side view of the HMD 100. In FIG. 5, a first area CR1 is a perspective view of the HMD 100 when in use, as viewed from the front right upper side, and a second area CR2 is a perspective view of the HMD 100 when in use, as viewed from the rear upper left side. FIG. 6 is a plan view of the HMD 100 when not in use. In FIG. 7, a first area DR1 is a front view of the HMD 100 when in use, with the shade 107 attached, and a second area DR2 is a perspective view of the HMD 100 when in use, with the shade 107 attached, as viewed from above and from the right side.

Next, a detailed structure of the HMD 100 will be described with reference to FIG. 8 and FIG. 9. In FIG. 8, a first area ER1 is a plan view of the HMD 100 when in use, and a second area ER2 is a front view of the HMD 100 when in use. In FIG. 9, a first area FR1 is a plan view of the HMD 100 when in use, and a second area FR2 is a right side view of the HMD 100 when in use.

In the optical device 100A, the first display device 101a for the left eye is provided with a first virtual image forming optical unit 103a that covers the front of the eye of the observer in a see-through manner, and a first image forming main body unit 105a that forms image light. The second display device 101b for the right eye is provided with a second virtual image forming optical unit 103b that covers the front of the eye of the observer in a see-through manner, and a second image forming main body unit 105b that forms image light. Each of the virtual image forming optical units 103a and 103b includes a light guide formed of a resin material or the like, and each of the image forming main body units 105a and 105b houses optical components and electronic components in an outer case 105d formed from a magnesium alloy or the like.

In the support device 100B, the left-side first temple 21a is fixed, via a hinge 22a, to the base unit 21c so as to be foldable to the inside thereof, and the right-side second temple 21b is fixed, via a hinge 22b, to the base unit 21c so as to be foldable to the inside thereof. A contact unit 24a is coupled to a tip portion 21p of the first temple 21a, via a universal joint 23a, which is a contact rotating portion. A contact unit 24b is coupled to the tip portion 21p of the second temple 21b, via a universal joint 23b, which is a contact rotating portion. Speakers 35 are built into the tip portions 21p of both the temples 21a and 21b. A cavity (not illustrated) is formed in a main body 21j of each of the temples 21a and 21b, and wiring lines WA1 for operating the speakers 35 are passed through the cavities. The contact units 24a and 24b can be inclined in various directions with respect to the main bodies 21j by the universal joints 23a and 23b.

Since the contact units 24a and 24b do not cover ears EA of the wearer US, each of the speakers 35 is disposed in a position separated from the ear EA (see FIG. 2). As a result, the ear EA can be exposed, and it is thus easier to hear sounds surrounding the HMD 100. The speaker 35 can have directivity, and it is thus easy for sound to reach only the ear EA of the wearer US. The speaker 35 may be a bone conduction type speaker.

The base unit 21c of the support device 100B includes a first arm 26a, a second arm 26b, a central member 26c, and a holding unit 26d. The first arm 26a and the second arm 26b are disposed so as to be curved substantially along the XZ plane. Both the arms 26a and 26b are flexible and are particularly susceptible to deformation in a direction substantially along the XZ plane. When no force is applied to the arms 26a and 26b, the arms 26a and 26b return to a more curved state in which a curvature thereof becomes greater, and narrow a gap between the temples 21a and 21b and the contact units 24a and 24b. Specifically, as illustrated in FIG. 6, the gap between the contact units 24a and 24b and the like is narrowed. In this way, as a result of forcibly widening the gap between the contact units 24a and 24b when in use or when being worn, a force is imparted to narrow the gap between the pair of contact units 24a and 24b, and thus, the pair of contact units 24a and 24b can come into contact with and press both sides of the head of the wearer US so as to sandwich the head, and the support device 100B can be fixed to the head of the wearer US in a stable manner. The central member 26c is a member integrated with the first arm 26a and the second arm 26b, and supports the arms 26a and 26b at a base side thereof. The central member 26c is coupled to the holding unit 26d, which is a component disposed obliquely downward via a rotating mechanism 27. The holding unit 26d is fixed to a central portion of the optical device 100A, that is, is fixed with respect to a bridge portion 103k at a center position sandwiched between the first virtual image forming optical unit 103a and the second virtual image forming optical unit 103b. The holding unit 26d includes an upper member 29a and a lower member 29b. The upper member 29a and the lower member 29b are fixed to each other via the bridge portion 103k of the optical device 100A. A part of the rotating mechanism 27 is formed on the upper member 29a of the holding unit 26d, and a camera 31 and a microphone 32 are incorporated therein. A pair of nose pads 61 are fixed to the lower member 29b via a support body 62. The nose pads 61 are indirectly fixed to the optical device 100A. The nose pads 61 may be directly fixed to the optical device 100A. The rotating mechanism 27 provided between the central member 26c and the holding unit 26d includes a pair of rotary support portions 27a and 27b and rotatably supports the optical device 100A about a rotation axis RX1, that is, the X-axis, that extends in the horizontal direction with respect to the support device 100B. As a result, the optical device 100A can be rotated around the rotary support portions 27a and 27b, and can be inclined in any direction along the YZ plane with respect to the first temple 21a, the second temple 21b, and the like fixed to the head.

The first temple 21a, the second temple 21b, the first arm 26a, the second arm 26b, and the central member 26c respectively form an integrated component, and substantially all of the first temple 21a, the second temple 21b, the first arm 26a, the second arm 26b, and the central member 26c are formed of a resin material, excepting portions such as screws or pins. However, these integrated components may be formed of a metal material, or may be formed of a metal core member covered by a resin material. Each of the contact units 24a and 24b is configured by a plate-shaped support member 28a and a pad 28b formed on the inner side thereof. A portion of each of the universal joints 23a and 23b is formed at one surface side of the support member 28a, and the pad 28b made of an elastic material is fixed to the other surface of the support member 28a, using an adhesive or the like. The support member 28a is formed of a resin material, but may be formed of a metal material, or of a metal core member covered with a resin material. The pad 28b is formed of an elastic material, such as rubber or a foamed resin, and fits closely to the surface of the side of the head. The main body or frame of the holding unit 26d is formed of a resin material, but may be formed of a metal material, or of a metal core member covered with a resin material.

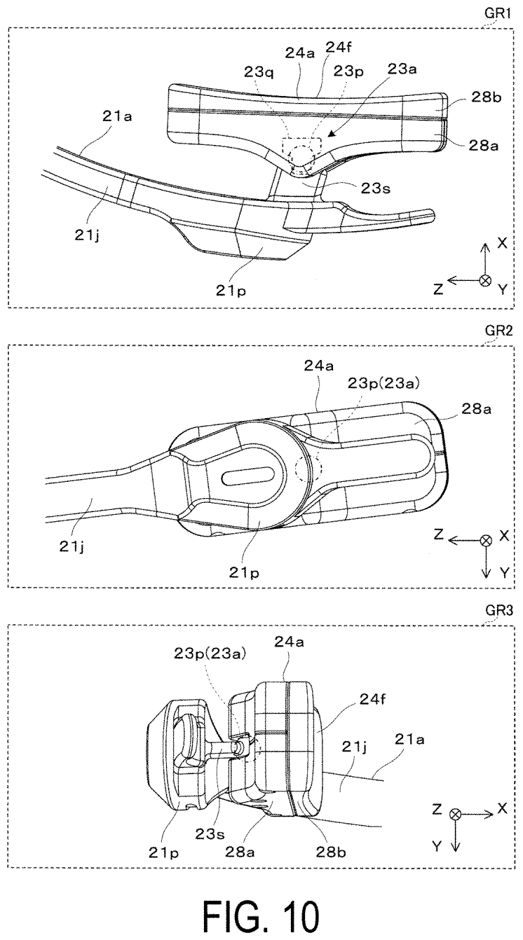

FIG. 10 is a diagram describing the appearance of the contact unit and the periphery thereof. In FIG. 10, a first area GR1 is a plan view of the contact unit 24a and the periphery thereof, a second area GR2 is a side view of the contact unit 24a and the periphery thereof, and a third area GR3 is a rear view of the contact unit 24a and the periphery thereof.

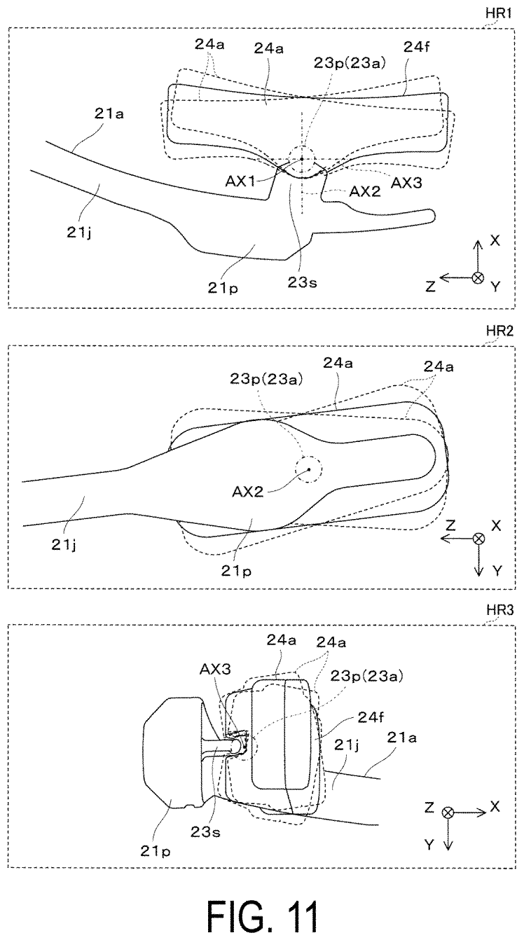

FIG. 11 is a diagram describing changes in posture by illustrating a contour of the contact unit illustrated in FIG. 10. In FIG. 11, a first area HR1 is a view describing a rotational operation of the contact unit 24a about a first axis AX1, a second area HR2 is a view describing a rotational operation of the contact unit 24a about a second axis AX2, and a third area HR1 is a view describing a rotational operation of the contact unit 24a about a third axis AX3.

Hereinafter, the structure and operations of the contact unit 24a and the periphery thereof will be described with reference to FIG. 10 and FIG. 11. The contact unit 24a is coupled, by the universal joint 23a, to the main body 21j of the first temple 21a, such that the contact unit 24a is movable. As illustrated in the first area GR1 of FIG. 10, the universal joint 23a is configured by a ball portion 23p and a ball retainer 23q. A stud 23s extending from the ball portion 23p is fixed inside the tip portion 21p of the first temple 21a, and the ball retainer 23q is embedded in the support member 28a of the contact unit 24a so as to rotatably support the ball portion 23p. In this way, as illustrated in the first area HR1 in FIG. 11, the contact unit 24a can swing so as to rotate about the first axis AX1 extending parallel to the Y-axis, and, as illustrated in the second area HR2 in FIG. 11, the contact unit 24a can swing so as to rotate about the second axis AX2 extending parallel to the X-axis. Further, as illustrated in the third area HR3 in FIG. 11, the contact unit 24a can swing so as to rotate about the third axis AX3 extending parallel to the Z-axis. In other words, the universal joint 23a allows the contact unit 24a to be inclined about three axes with respect to the main body 21j. A movable range of the contact unit 24a about the first to third axes AX1 to AX3 is set from approximately 10° to 30°. Note that the first to third axes AX1 to AX3 are rotary shafts for convenience of description, and the contact unit 24a can be rotated about any of the axes, of the first to third axes AX1 to AX3. In addition, the second axis AX2 and the third axis AX3 are inclined with respect to the X-axis and the Z-axis in accordance with the posture of the tip portion 21p of the first temple 21a, but only the movable range of the contact unit 24a changes according to the posture of the tip portion 21p, and the free and smooth movable state of the contact unit 24a is maintained regardless of the posture of the tip portion 21p.

An inner surface 24f of the contact unit 24a is a concave surface and is formed in a spherical shape. The curvature of the inner surface 24f is an inverted curvature of the curvature of the head of the wearer US. When the contact unit 24a is caused to come into contact with and press the side of the head of the wearer US, the inner surface 24f of the contact unit 24a can be caused to fit closely with the side of the head of the wearer US. In this way, a difference in the shape of the head can be absorbed and a contact area of the contact unit 24a can be secured, and a large holding force by the temple 21a can be secured. Because the side of the head of the wearer US is a relatively flat portion and extends in the vertical direction, although the first temple 21a cannot be supported in a stable manner, as on the top of the ear, the contact unit 24a can be worn over a significantly larger area than the top of the ear. Therefore, compared to a case in which an excessive force is concentrated in a narrow region on the top of the ear, the force can be distributed and pressure can be reduced, and thus discomfort to the wearer US caused by wearing the contact unit 24a can be reduced. As a result, an effect is generated of reducing a load on the nose of the wearer US, and a comfortable fit can be realized. The area of the inner surface 24f of the contact unit 24a is set as appropriate while taking the weight of the HMD 100 into account, and, in the illustrated example, is set to approximately 5 cm×2 cm. The contact unit 24a is not limited being disposed so as to be horizontally long, and may be disposed so as to be vertically long. Furthermore, an intermediate state between the lateral direction and the vertical direction (that is, an oblique state with respect to the main body 21j) can be taken as a reference for the longitudinal direction of the contact unit 24a. In other words, with respect to the longitudinal direction of the contact unit 24a, the contact unit 24a can be mounted and fixed to the head in a state in which the contact unit 24a is rotated about the X-axis within a predetermined angular range, taking a state extending in parallel to the Y-axis as the reference.

While the above is a description of the first temple 21a and the contact unit 24a provided thereon, the second temple 21b and the contact unit 24b provided thereon also have the same structure as the first temple 21a and the contact unit 24a, and thus a description of the second temple 21b and the contact unit 24b will be omitted.

The arms 26a and 26b, or the main body 21j of the first temple 21a and the second temple 21b are flexible and can adjust the spacing between the pair of tip portions 21p as a result of the wearer US pushing them apart. In this way, the wearer US can cause the pair of contact units 24a and 24b to come into contact with appropriate positions on the sides of the head facing each other, and, as a result of releasing hands from the pair of contact units 24a and 24b, the contact units 24a and 24b can be urged into a close fit with both sides of the head so as to sandwich the head. At this time, the contact units 24a and 24b can be inclined in any direction by the universal joints 23a and 23b, and the close fit can be secured over the entire inner surface 24f. The pressing force or the urging force of one of the contact units 24a or 24b with respect to the side of the head can be approximately 3 to 4 N, for example, taking the weight of the entire device into account, but the pressing force is not limited thereto. As a result of the contact units 24a and 24b sandwiching the head with an appropriate force, the pair of contact units 24a and 24b are supported by the sides of the head, and slipping due to the load of the first temple 21a and the second temple 21b can be prevented. Thus, the entire HMD 100, including the optical device 100A and the support device 100B, can be fixed in a stable manner with respect to the head of the wearer US.

From the perspective of stability of the support, the pair of contact units 24a and 24b are preferably disposed on opposite sides of the head of the wearer US so as to sandwich the head. In other words, the inner surfaces 24f of the pair of contact units 24a and 24b are preferably disposed so that approximate planes thereof are substantially parallel. However, the inner surfaces 24f of the pair of contact units 24a and 24b need not necessarily be strictly parallel, and as long as a pressing force with respect to the pair of contact units 24a and 24b is secured to some degree, the state of the pair of contact units 24a and 24b being supported by the sides of the head can be secured. In order to properly position the pair of contact units 24a and 24b with respect to the head, the lengths of the first temple 21a and the second temple 21b are also involved. The lengths of the first temple 21a and the second temple 21b can be determined using the assumed standard wearer US as a model.

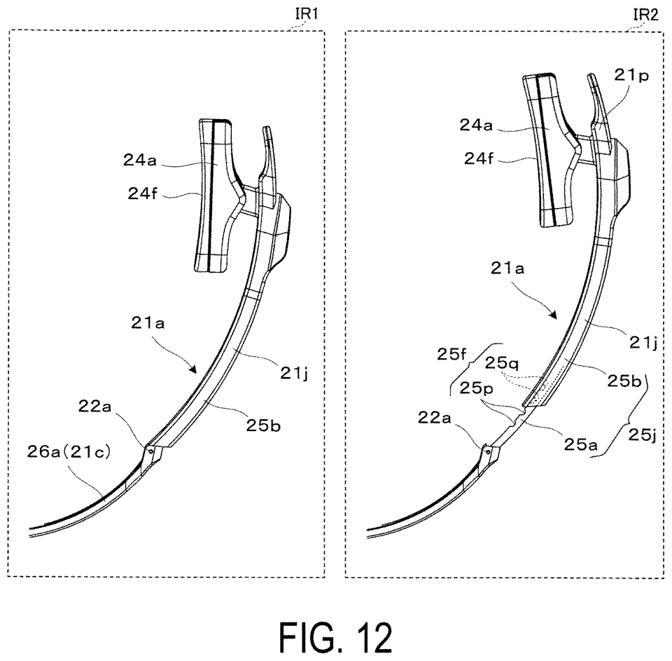

FIG. 12 is a plan view illustrating a modified example of the structure of the first temple 21a. In FIG. 12, a first area IR1 illustrates a basic state of the first temple 21a, and a second area IR2 illustrates a state in which the first temple 21a is extended. The main body 21j of the first temple 21a includes a slide shaft 25a and an outer cylinder 25b. The base of the slide shaft 25a is supported by the first arm 26a of the base unit 21c. The slide shaft 25a and the outer cylinder 25b function as a length adjustment structure 25j of the first temple 21a. In other words, the length of the first temple 21a can be manually adjusted by causing the slide shaft 25a to slide within the outer cylinder 25b. In other words, the first temple 21a is formed so as to be extendable, and a distance from the base of the first temple 21a to the contact unit 24a can be adjusted. A plurality of recesses 25p are periodically formed on the slide shaft 25a, and a plurality of protrusions 25q that deform under pressure are formed on the inside of the outer cylinder 25b at intervals corresponding to the plurality of recesses 25p. The recesses 25p and the protrusions 25q configure an engagement structure 25f, and allow stepwise movement of the slide shaft 25a. In other words, the main body 21j of the first temple 21a can be extended in a stepwise manner in multiple stages.

Although the description of the second temple 21b is omitted, the second temple 21b can be made extendable in a similar manner to the first temple 21a. By appropriately extending and contracting the main bodies 21j of the temples 21a and 21b, the pair of contact units 24a and 24b are easily disposed on substantially opposite sides of the head of the wearer US so as to sandwich the head, for a variety of the wearers US.

Returning to FIG. 8 and the like, the hinges 22a and 22b are not necessarily required in the base unit 21c of the support device 100B, and the first temple 21a and the second temple 21b can have a non-folding structure.

By placing the base unit 21c in the center of the support device 100B and supporting the pair of nose pads 61 on the central member 26c, it is possible to center the pair of nose pads 61 in the support device 100B with respect to the left and right directions or in the X direction, and it is thus easier to arrange the optical device 100A in alignment with respect to the left and right directions in relation to the eyes of the wearer US. In the HMD 100 of the embodiment, there is a high degree of freedom with respect to the arrangement or the fixing position of the contact units 24a and 24b, and the optical device 100A tends to be easily displaced with respect to the left and right directions. By providing the pair of nose pads 61 directly or indirectly on the support device 100B, it becomes easy to appropriately position the support device 100B with respect to the head of the wearer US, and it also becomes easy to appropriately position the optical device 100A with respect to the eyes of the wearer US.

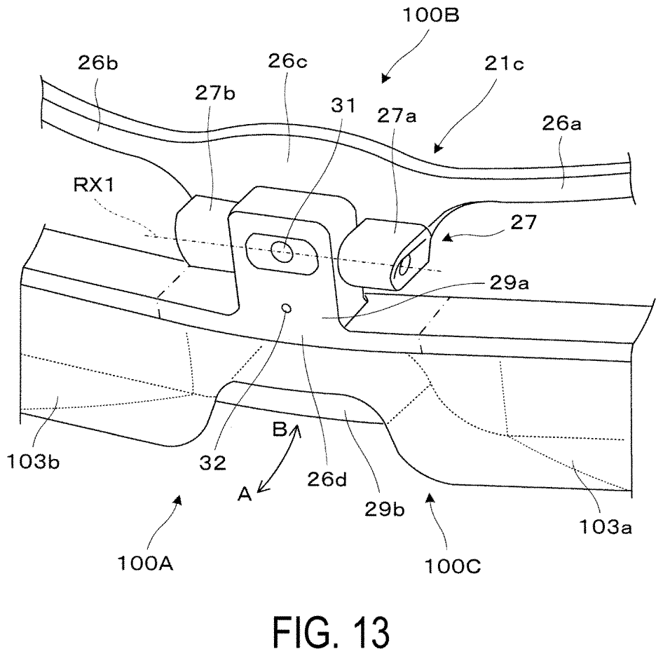

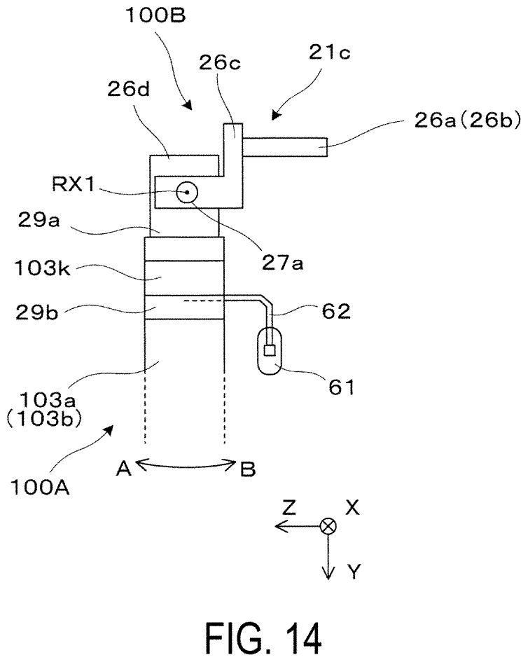

FIG. 13 is a perspective view illustrating the base unit 21c of the support device 100B. Further, FIG. 14 is a conceptual partial side cross-sectional view illustrating the periphery of the base unit 21c. The rotary support portions 27a and 27b are provided between the central member 26c and the holding unit 26d on the base unit 21c, and these rotary support portions 27a and 27b function as the rotating mechanism 27 for the optical device 100A. The optical device 100A can be manually rotated about the rotation axis RX1 using the rotary support portions 27a and 27b, as indicated by an arrow AB in FIG. 13, and the posture of the optical device 100A can be inclined in any direction along the vertical plane, namely, the YZ plane. In other words, the rotating mechanism 27 rotatably supports the optical device 100A about the rotation axis RX1 or the horizontal axis. In this way, the position at which the virtual image is visible in front of the wearer US can be changed in the vertical direction, or a distance from the eyes of the wearer US to the first virtual image forming optical unit 103A and the second virtual image forming optical unit 103B of the optical device 100A can also be increased or decreased. The rotating mechanism 27 may be capable of smooth, continuous rotation, but can also incorporate a click movement mechanism (not illustrated) by which the optical device 100A can be held at a discrete angular posture in a stepwise manner.

In the illustrated example, the holding unit 26d includes the upper member 29a and the lower member 29b that are separated from each other, but the upper and lower members 29a and 29b can be an integrated member in which they are coupled to each other.

With respect to the nose pad 61, the lower member 29b of the central member 26c can be detachably attached to the bridge portion 103k of the optical device 100A, and the nose pad 61 can be replaced along with the lower member 29b. In this way, the nose pad 61 which has a suitable size for the face of the wearer US and for which the arrangement using the support body 62 is appropriately adjusted can be attached to the support device 100B or the optical device 100A.

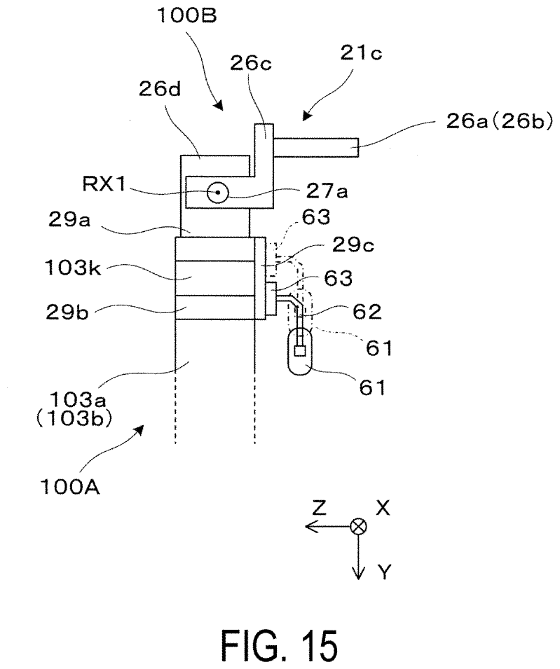

FIG. 15 is a diagram illustrating a modified example of the nose pad 61, the support body 62, and the like illustrated in FIG. 14. In this case, a wall 29c that connects the upper member 29a and the lower member 29b of the central member 26c is provided, and a mounting member 63 of the support body 62 can move in the vertical direction with respect to the wall 29c. The mounting member 63 illustrated by solid lines in FIG. 15 is disposed at a lower end position, and the mounting member 63 illustrated by dot-dash lines in FIG. 15 is disposed at an upper end position. A slide mechanism or magnet (not illustrated) is incorporated between the wall 29c and the mounting member 63, and the mounting member 63 can be raised and lowered smoothly or raised and lowered in a stepwise manner. In this way, the arrangement of the nose pad 61 with respect to the optical device 100A and the support device 100B can be changed and adjusted, and the height position of the optical device 100A with respect to the eyes of the wearer US can be easily adjusted.

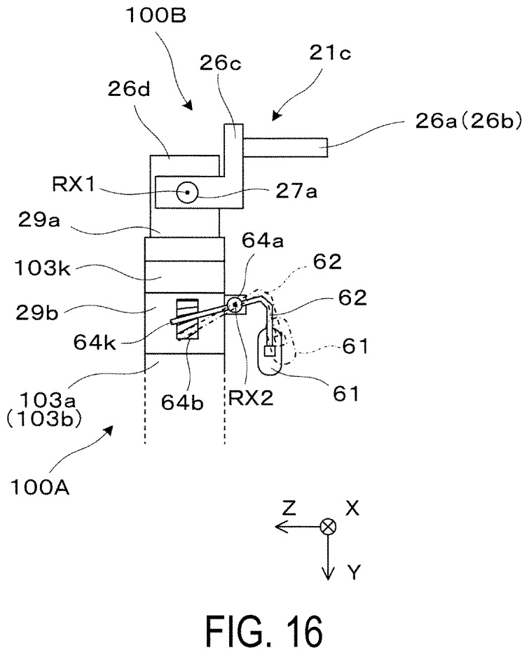

FIG. 16 is a diagram illustrating another modified example of the nose pad 61, the support body 62, and the like illustrated in FIG. 14. In this case, the rotary support unit 64a is provided on the lower member 29b of the central member 26c, and the support body 62 of the nose pad 61 can be rotated about the rotation axis RX2. A tip 64k of the support body 62 on the opposite side from the nose pad 61 extends to a stopper 64b, and the rotation of the support body 62 is thus limited. When the nose pad 61 is manually and forcibly rotated about the rotation axis RX2, the tip 64k of the support body 62 is rotationally moved in a stepwise manner against the resistance of the stopper 64b, and the posture of the support body 62 can be changed. In this way, the nose pad 61 also rotates about the rotation axis RX2 and moves to a position desired by the wearer US. With such a rotation mechanism also, the arrangement of the nose pad 61 with respect to the optical device 100A and the support device 100B can be changed and adjusted, and the distance to and the height position of the optical device 100A with respect to the eyes of the wearer US can be easily adjusted.

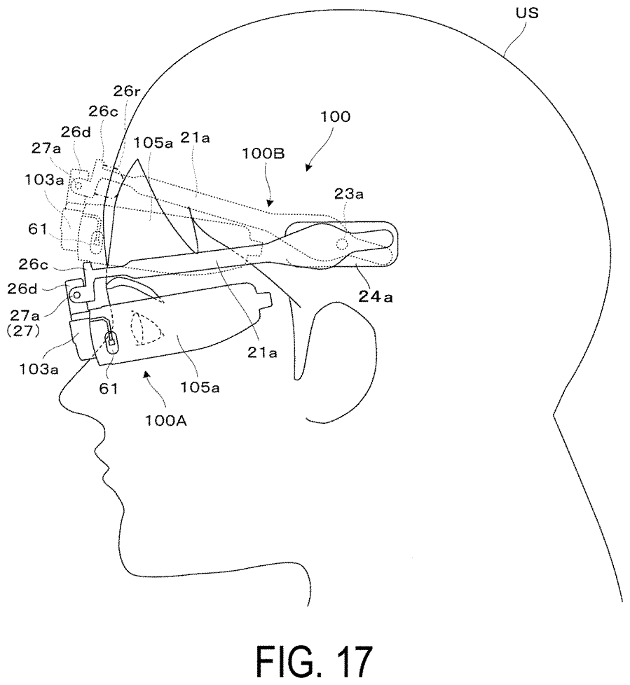

FIG. 17 is a diagram illustrating lifting up of the optical device 100A. In the support device 100B, since the contact unit 24a is supported by the universal joint 23a, the illustrated first temple 21a can be rotated clockwise about the axis of the universal joint 23a. In other words, the wearer US can move the optical device 100A upward by hand, and can retract the virtual image forming optical unit 103a from in front of the line of sight of the eyes of the wearer US. At this time, if the nose pad 61 is supported on the surface of the brow bone or the frontal bone, it is possible to prevent the optical device 100A from dropping back to its original position. When the nose pad 61 does not function as a downward slipping prevention member, the optical device 100A can be prevented from dropping back to its original position by additionally providing a friction pad 26r on a rear surface of the holding unit 26d, in the central member 26c of the support device 100B.

Returning to FIG. 2, the shade 107 may be detachably attached so as to cover the front surface of the optical device 100A. The shade 107 includes a light reducing portion 107a and a frame 107c. As illustrated in FIG. 7, the frame 107c is fixed such that a central portion 107j is fitted into the central member 26c of the support device 100B or into gaps GA (see FIG. 8) of the holding unit 26d. A clicking feeling is caused to be generated when attaching and removing the shade 107. Although a specific description of an attachment mechanism of the shade 107 is omitted, a general mechanical mechanism can be used. Also, attachment locations of the shade 107 are not limited to those illustrated and can be set to a variety of locations.

The auxiliary member 108 illustrated in FIG. 2 has a function of assisting in preventing movement of the contact units 24a and 24b, and includes a strap 108a that couples the pair of tip portions 21p of the first temple 21a and the second temple 21b, and a clip 108b that adjusts slack in the strap 108a. In this case, using a simple technique of adjusting a length and fastening state of the strap 108a using the clip 108b, it is possible to prevent an arrangement, with respect to the head, of the optical device 100A that is the image light generating device from changing, that is, prevent positional displacement thereof, and unintentional falling of the HMD 100 can be prevented. The strap 108a is not limited to a string-like strap, and may have a band shape. The clip 108b can have various configurations as long as the clip 108b can fasten the strap 108a at any location. The auxiliary member 108 can be detachably attached to the temples 21a and 21b, and the like.

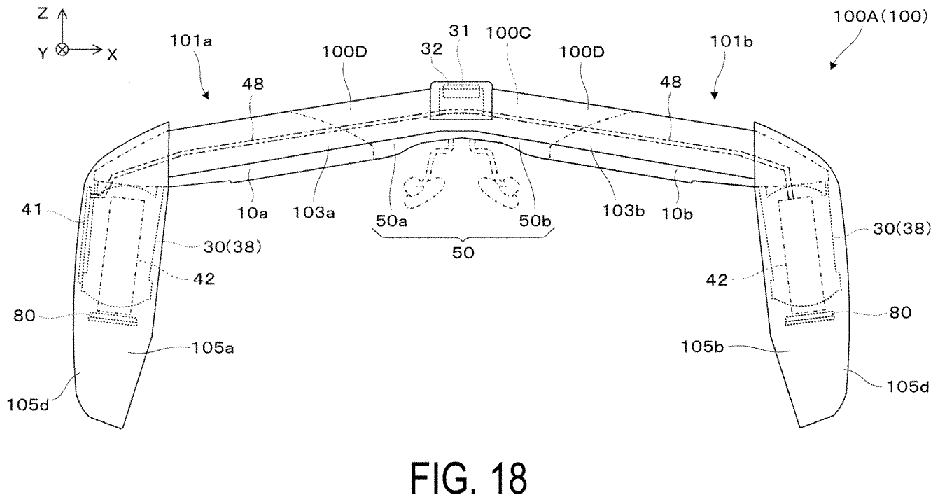

The internal structure of the optical device 100A and the like will be described with reference to FIG. 18. The first image forming main body unit 105a of the first display device 101a for the left eye holds a display element 80, a projection lens 30, electronic circuit boards 41 and 42, and the like in the outer case 105d. A lens barrel 38 of the projection lens 30 fixes a lens element and the display element 80 that configure the projection lens 30 in alignment with each other. The display element 80, the projection lens 30, and the electronic circuit boards 41 and 42 are fixed in the metal outer case 105d in a state of alignment with each other, via an attachment member (not illustrated). In particular, the projection lens 30 is fixed in a state of alignment with a tip portion of the first virtual image forming optical unit 103a also. The projection lens 30 is disposed upstream on an optical path with respect to the first virtual image forming optical unit 103a, and configures a part of an imaging system. The electronic circuit board 41 is a signal processing board that processes signals from the external device 200 or the relay 110 illustrated in FIG. 1. The electronic circuit board 41 manages and controls a display operation of the electronic circuit board 42. The electronic circuit board 42 is a drive circuit board that drives the display element 80 in the first image forming main body unit 105a, and operates under the control of the electronic circuit board 41.

The second image forming main body unit 105b of the second display device 101b for the right eye holds the display element 80, the projection lens 30, the electronic circuit board 42, and the like in the outer case 105d. The display element 80, the projection lens 30, and the electronic circuit board 42 are fixed in the metal outer case 105d in a state of alignment with each other. In particular, the projection lens 30 is fixed in a state of alignment with a tip portion of the second virtual image forming optical unit 103b also. In the second image forming main body unit 105b for the right eye, the projection lens 30 is disposed upstream on an optical path with respect to the second virtual image forming optical unit 103b, and configures a part of the imaging system. The electronic circuit board 42 is a drive circuit board that drives the display element 80 in the second image forming main body unit 105b, and operates under the control of the electronic circuit board 41 provided in the separate first image forming main body unit 105a.

The first and second virtual image forming optical units 103a and 103b are not separate units but are coupled at end portions thereof facing each other, thus forming a see-through light-guiding unit 100C that is an integrated member. The see-through light-guiding unit 100C is provided with a pair of light-guiding members 10a and 10b that guide image light from the display elements 80, and a central member 50 that enables superimposed viewing of an external world image. The pair of light-guiding members 10a and 10b are a pair of optical members that contribute to the formation of the virtual image, while internally propagating the image light. The central member 50 includes a pair of light transmission units 50a and 50b. The light transmission unit 50a is joined to the light-guiding member 10a, and the light transmission unit 50b is joined to the light-guiding member 10b. The see-through light-guiding unit 100C is a combined-type light-guiding device that provides an image for both eyes to the wearer US by guiding light, and is supported by the image forming main body units 105a and 105b as a result of both of end portions, namely, tip ends of the light-guiding members 10a and 10b, being fitted into the outer cases 105d.

An upper cover 100D is fixed to the top surface of the see-through light-guiding unit 100C. A thin, narrow space is formed between the upper cover 100D and the see-through light-guiding unit 100C, and a signal line 48 that electrically couples the first image forming main body unit 105a and the second image forming main body unit 105b extends through the space. Note that the upper cover 100D can be integrated with the holding unit 26d that configures the base unit 21c of the support device 100B illustrated in FIG. 8, or may be separate from the holding unit 26d.

The display element 80 incorporated into the first image forming main body unit 105a is a spontaneous emission display device that enables two-dimensional display, and operates using a dot-matrix system. Each of the display elements 80 is specifically assumed to be an organic EL (EL) display panel, but the display element 80 is not limited thereto, and may be a panel for a liquid crystal display (LCD). When the panel for the LCD is used, a compatible illumination source is required. The display element 80 is driven by the electronic circuit board 42, and can form a color image on a square display surface and display a two-dimensional video or still image. The display element 80 incorporated into the second image forming main body unit 105b has the same structure as the display element 80 incorporated into the first image forming main body unit 105a.

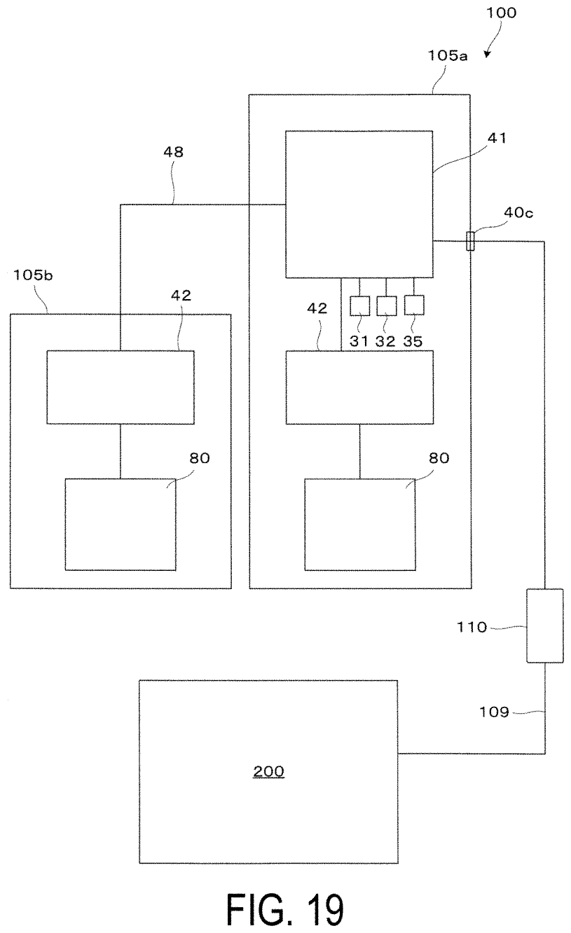

Next, an electrical configuration of the HMD 100 will be described with reference to FIG. 19. Electronic circuits are divided into those incorporated into the first image forming main body unit 105a for the left eye illustrated in FIG. 18, and those incorporated into the second image forming main body unit 105b for the right eye illustrated in FIG. 18. The circuits incorporated into the first image forming main body unit 105a include the two electronic circuit boards 41 and 42, and the circuits incorporated into the second image forming main body unit 105b include the single electronic circuit board 42.

The electronic circuit board 41 incorporated into the first image forming main body unit 105a is coupled to the external device 200 via a connector 40c, the cable 109, and the relay 110. The electronic circuit board 41 branches signals received from the external device 200 or the relay 110 and distributes the signals to the electronic circuit board 42 of the first image forming main body unit 105a and the electronic circuit board 42 of the second image forming main body unit 105b. In this case, a circuit external to the HMD 100, such as the external device 200, has a role in managing the overall operation of the HMD 100, and the electronic circuit board 41 operates under the control of a circuit device external to the HMD 100. The electronic circuit board 41 manages operations of the camera 31, the microphone 32, and the speaker 35. The electronic circuit board 41 causes the camera 31 to capture an image at an appropriate timing, reads voice emitted by the wearer US using the microphone 32, and notifies the wearer US of voice information using the speaker 35. Although not illustrated, various sensors such as a temperature sensor, an external light sensor, an acceleration sensor, and the like are incorporated into the first image forming main body unit 105a.

The electronic circuit board 42 incorporated into the first image forming main body unit 105a operates in response to a display signal output from the electronic circuit board 41, as the drive circuit board that drives the display element 80. Although a detailed description thereof is omitted, each of the electronic circuit boards 42 is provided with an IF circuit, a scanning drive circuit, a signal drive circuit, and the like, for example, receives image data or image signals output from the electronic circuit board 41 and causes the display element 80 to perform two-dimensional image display. The electronic circuit board 42 outputs a drive signal corresponding to the image to the display element 80.

The electronic circuit board 42 incorporated into the second image forming main body unit 105b has the same structure as the electronic circuit board 42 incorporated into the first image forming main body unit 105a, and operates in response to the display signal output from the electronic circuit board 41, as the driving circuit board that drives the display element 80 provided in the second image forming main body unit 105b.

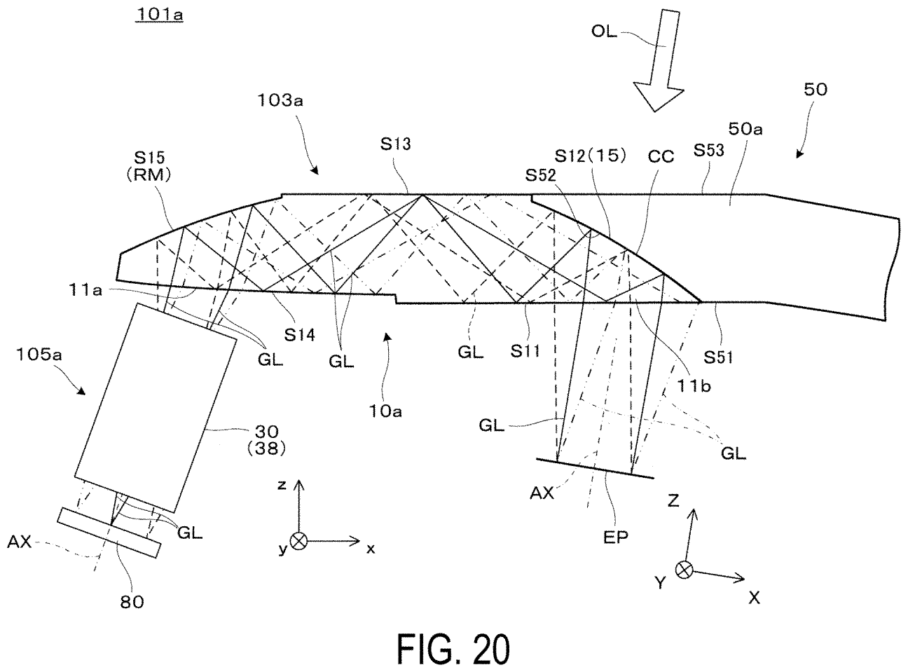

FIG. 20 is a diagram illustrating a part of the first display device 101a, and, in particular, describes an optical structure of the first virtual image forming optical unit 103a. As described above, the HMD 100 is configured by the first display device 101a and the second display device 101b (see FIG. 1 and the like), but, since the first display device 101a and the second display device 101b are left-right symmetric and have an equivalent structure, only the first display device 101a will be described, and a description of the second display device 101b will be omitted. Note that in FIG. 20, x, y, and z are an orthogonal coordinate system, the x direction and the y direction are parallel to a first surface S11 and a third surface S13, and the z direction is perpendicular to the first surface S11 and the third surface S13.

The light-guiding member 10a of the first virtual image forming optical unit 103a is joined to the light transmission unit 50a via an adhesive layer CC. In other words, a second transmission surface S52 of the light transmission unit 50a is disposed facing a second surface S12 of the light-guiding member 10a and has the same shape as the second surface S12. The light-guiding member 10a and the light transmission unit 50a have a structure in which a surface of a main body member that provides a three-dimensional shape including an optical surface is covered with a thin hard coat layer. The main body members of the light-guiding member 10a and the light transmission unit 50a are formed from a resin material with high optical transparency in a visible range and are molded, for example, by pouring a thermoplastic resin into a mold and solidifying the resin.

Below, an optical path of image light GL will be briefly described. The light-guiding member 10a guides the image light GL from the projection lens 30 toward the eye of the wearer US, by reflecting the image light GL using the first to fifth surfaces S11 to S15, and the like. Specifically, the image light GL from the projection lens 30 is first incident on a part of the fourth face S14 formed on a light incidence portion 11a and reflected by the fifth face S15 that is an inner face of a reflection film RM. Then, the image light GL is incident once more from the inner side on the fourth surface S14 and is totally reflected, is incident on and totally reflected by the third surface S13, and is incident on and totally reflected by the first surface S11. The image light GL totally reflected by the first surface S11 is incident on the second surface S12, is partially reflected while also partially passing through a half mirror 15 provided on the second surface S12, and is once more incident on and passes through a part of the first surface S11 formed on a light emission portion 11b. The image light GL that has passed through the first surface S11 travels as a whole along an optical axis AX that is substantially parallel to the Z direction, and is incident as a substantially parallel luminous flux on an eye ring EP on which the eye of the wearer US is disposed. In other words, the wearer US observes the image formed by the image light GL as the virtual image.

The first virtual image forming optical unit 103a causes the wearer US to visually recognize the image light using the light-guiding member 10a, and also causes the wearer US to observe the external world image having little distortion, by combining the light-guiding member 10a and the light transmission unit 50a. At this time, since the third surface S13 and the first surface S11 are planes that are substantially parallel to each other, diopter is substantially zero with respect to the observation transmitted through this section, so almost no aberration or the like occurs in external light OL. Further, since a third transmission surface S53 and a first transmission surface S51 are planes that are substantially parallel to each other, and furthermore, the third transmission surface S53 and the first surface S11 are planes that are substantially parallel to each other, almost no aberration or the like occurs. As described above, the wearer US observes the external world image that has no distortion through the light transmission unit 50a.

In the HMD 100 described above, the contact units 24a and 24b are pressed by the main bodies 21j of the temples 21a and 21b and caused to come into contact with the flat portions of the head, specifically against the sides of the head. Since the contact units 24a and 24b are coupled to the main bodies 21j by the universal joints 23a and 23b, the posture of the contact units 24a and 24b relative to the flat portions of the head that are the contact targets, specifically, the posture with respect to the sides of the head, is a posture suitable for being pressed, and the HMD 100 can be fixed with respect to the head in a stable state, using the contact units 24a and 24b. As a result, it is possible to perceive necessary environmental sound while wearing the HMD 100, and limitations relating to the external shape of the HMD 100 can be reduced by the contact units 24a and 24b that can easily be made relatively small. Further, the HMD 100 of the embodiment can be worn in a similar way to glasses by simply widening the first temple 21a and the second temple 21b on the tip end side thereof, and thus, a mounting operation is simple, and left-right alignment is also simple using the nose pads 61.

### MODIFIED EXAMPLES AND OTHER ITEMS

The shapes of the first temple 21a, the second temple 21b, the first arm 26a, the second arm 26b, the central member 26c, and the like that configure the support device 100B described above are merely examples, and various shapes and structures can be adopted to the extent that similar functions can be achieved.

The structure and shape of the optical device 100A described above is merely an example, and various optical systems that achieve a see-through type HMD can be adopted. For example, the optical device 100A can be a device provided with only one of the first display device 101a and the second display device 101b.

The outline shape of each of the contact units 24a and 24b is not limited to the rectangular shape exemplified above, and can be another polygonal shape, such as a circular shape, an elliptical shape, a hexagonal shape, or the like. The inner surface 24f of each of the contact units 24a and 24b or the pad 28b need not necessarily be a single surface, and may have a contact surface divided into a plurality of regions.

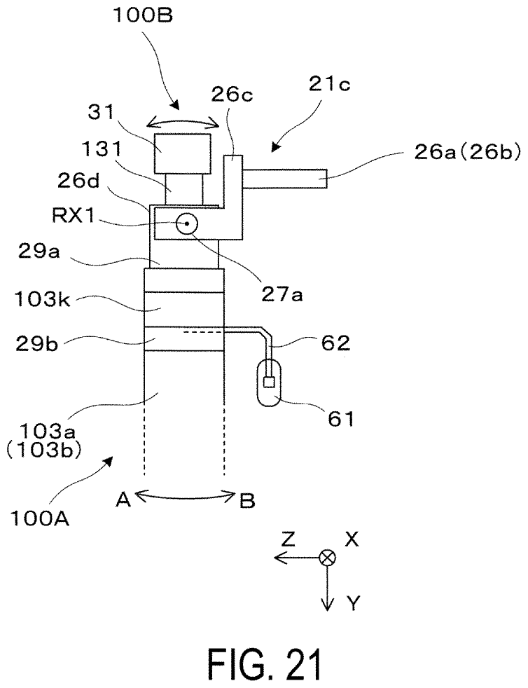

Since the camera 31 is tilted upward by the lifting up of the optical device 100A, in order to maintain the field of view of the camera 31, a mechanism for adjusting the posture of the camera 31 with respect to the optical device 100A can be added. As illustrated in FIG. 21, the camera 31 is not fixed directly to the holding unit 26d of the support device 100B and is fixed via a mount 131. The mount 131 is operated manually or electrically to tilt the camera 31 in a direction along the YZ plane. As a result, the field of view of the camera 31 can be changed in the up-down direction, and even when the optical device 100A is lifted up, the posture of the camera 31 can be maintained such that the horizontal direction thereof is front-facing, for example, and the front-facing direction can be captured.

When the optical device 100A is lifted up, the nose pads 61 and the friction pad 26r are used to inhibit the downward slipping of the optical device 100A. However, inhibiting the downward slipping of the optical device 100A can also be achieved by providing, in the contact units 24a and 24b, an angle retention mechanism that helps maintain an angular relationship with the temples 21a and 21b.

In the description above, the display element 80 is a panel for an organic EL display panel or LCD, but the display element 80 may be a spontaneous light-emitting display element represented by an LED array, a laser array, a quantum dot light-emitting element, or the like. Furthermore, the display element 80 may be a display using a laser scanner that incorporates a laser light source and a scanner. Note that liquid crystal on silicon (LCOS) technology may be used instead of the LCD panel.

The electronic circuit boards 41 and 42 are not limited to the functions described in the embodiment above, and can be caused to have various functions.

A head-mounted display (HMD) according to a specific aspect includes an image light generating device configured to form a virtual image, and a support device including a pair of temples and configured to support the image light generating device from above. The temple includes a contact unit coupled to a main body of the temple by a universal joint, and causes the contact unit to contact while pressing the contact unit.

In the wearable display device described above, the contact unit comes into contact as a result of being pressed by the main body of the temple, and, since the contact unit is coupled to the main body by the universal joint, a posture of the contact unit with respect to a contact target becomes appropriate for the pressing, and, using the contact unit, the head-mounted display can be fixed with respect to a head in a stable manner.

According to a specific aspect, the pair of temples include a pair of the contact units caused to come into contact with a pair of sides of a head while sandwiching the head, each of the pair of contact units being coupled to the main body of the temple by the universal joint. In this case, using the pair of contact units, the temples can be fixed to the head so as to sandwich the head, and the image light generating device can be fixed to the head via the temples.

According to another aspect, the contact unit includes a support member having a plate shape, a portion of the universal joint being formed at one surface side of the support member, and a pad made of an elastic material and fixed on another surface of the support member. In this case, the contact unit can be caused to come into contact with the head in a state of an elastic close fit, and the fixing of the temple to the head can be stabilized.

According to yet another aspect, the universal joint is configured for the contact unit to perform a three-axis tilt with respect to the main body. In this case, a movable state of the contact unit with respect to the temple can be diversified, it is easy to cause the contact unit to fit closely to the head, and the temple can also be rotated in a state of remaining fixed with respect to the head.

According to yet another aspect, the universal joint includes a ball portion and a ball retainer. In this case, the universal joint can be downsized through a simple structure, and the contact unit and the temple can also be downsized.

According to yet another aspect, the support device includes a rotating mechanism configured to rotatably support the image light generating device about a horizontal axis. In this case, the posture and arrangement of the image light generating device with respect to the support unit can be adjusted, and the posture and arrangement of the image light generating device with respect to the head can be adjusted.

Yet another aspect includes a nose pad indirectly or directly fixed to the image light generating device. In this case, an arrangement of the image light generating device with respect to a face can be caused to be an initial state.

According to yet another aspect, the temple is formed to be extensible, and a distance from a base of the temple to the contact unit is adjustable. In this case, the arrangement of the contact unit with respect to the main body of the temple can be adjusted.

Yet another aspect includes an auxiliary member configured to assist in inhibiting movement of the contact unit. In this case, it is possible to suppress the contact unit from moving from an initial fixed position and changing the arrangement of the image light generating unit with respect to the face.

According to yet another aspect, the auxiliary member includes a strap that couples a pair of tips of the temples and a clip that adjusts slack in the strap. In this case, using a simple technique, it is possible to suppress an arrangement of the image light generating unit with respect to the head from changing.

What is claimed is:

1. A head-mounted display comprising:
an image light generating device configured to form a virtual image; and
a support device including a pair of temples and configured to support the image light generating device from above, wherein
the temple includes a contact unit coupled to a main body of the temple by a universal joint, and causes the contact unit to contact with pressure.

2. The head-mounted display according to claim 1, wherein
the pair of temples include a pair of the contact units caused to come into contact with a pair of sides of a head while sandwiching the head, each of the pair of contact units being coupled to the main body of the temple by the universal joint.

3. The head-mounted display according to claim 1, wherein
the contact unit includes
a support member having a plate shape, a portion of the universal joint being formed at one surface side of the support member, and
a pad made of an elastic material and fixed at another surface of the support member.

4. The head-mounted display according to claim 1, wherein
the universal joint allows the contact unit to tilt, along three axes, with respect to the main body.

5. The head-mounted display according to claim 4, wherein
the universal joint includes a ball portion and a ball retainer.

6. The head-mounted display of claim 1, wherein
the support device includes a rotating mechanism configured to rotatably support the image light generating device about a horizontal axis.

7. The head-mounted display according to claim 1, comprising:
a nose pad indirectly or directly fixed to the image light generating device.

8. The head-mounted display according to claim 1, wherein
the temple is formed to be extensible, and a distance from a base of the temple to the contact unit is adjustable.

9. The head-mounted display according to claim 1, comprising:
an auxiliary member configured to assist in inhibiting movement of the contact unit.

10. The head-mounted display according to claim 9, wherein
the auxiliary member includes a strap that couples a pair of tips of the temples and a clip that adjusts slack in the strap.
